(19) United States
(12) Patent Application Publication
(10) Pub. No.: US 2009/0265891 A1
(43) Pub. Date: Oct. 29, 2009

(54) Hand tightened knob or key

(76) Inventors: Barry Michael Pett, Christchurch (NZ); Andrew Jackson, Wellington (NZ)

Correspondence Address: JACOBSON HOLMAN PLLC, 400 SEVENTH STREET N.W., SUITE 600, WASHINGTON, DC, 20004, US

(21) Appl. No.: 11/629,701

(22) PCT Filed: Jun. 15, 2005
(86) PCT No.: PCT/NZ05/00128

§ 371 Date: Dec. 15, 2006

(30) Foreign Application Priority Data
Jun. 15, 2004 (NZ) 533551

(51) Int. Cl. B25G 1/10

(52) U.S. Cl. 16/430

(57) ABSTRACT

A method and apparatus which can be used to connect two items together using a knob, key, handle or lever. The knob has a central boss from which extend at least two curved, in plan, arms. The curved shape of the arms is adapted in use to aid grip. or purchase during tightening or aid grip or purchase during releasing motion of the boss to thereby minimise the risk of overtightening.

### FIELD OF THE INVENTION

The invention relates to a knob, key, handle or lever and particularly to a knob or key designed, depending on its orientation, to be either easy to turn to tighten or release, or easy to turn and not overtighten.

### BACKGROUND TO THE INVENTION

At present a large number of different types and shapes of knob, handle or lever are available for connect to or attachment to a threaded or otherwise shaped member to enable a person to rotate the knob, handle or lever relative to the threaded or otherwise shaped member. The types of connection where such a relationship might be used are to numerous to detail but they will be appreciated and recognised by a skilled addressee.

Examples of such a connection are where a knob, handle or lever is used instead of a nut on any threaded bolt or other member and there is no need for use of a spanner or the like to tighten the parts together or to undo or release the parts. The knob is used to tighten, clamp or otherwise engage two or more members together or to release or undo the connection. For example is such a situation where a wing nut or the like might be used.

An object of the invention is to provide a useful alternative to an existing knob, handle or lever which is designed, depending on its orientation, to be either easy to turn to tighten or release or easy not to overtighten.

Further objects and advantages of the invention will become apparent from the following description which is given by way of example only.

### SUMMARY OF THE INVENTION

According to a first aspect of the invention there is provided a knob, key, handle or lever with a central boss from which extend at least two curved in plan arms, the curved shape of the arms being adapted in use to either aid grip or purchase during tightening or aid grip or purchase during releasing motion of the boss.

According to a second aspect of the invention there is provided a knob, key, handle or lever with a central boss from which extend three curved in plan arms spaced equidistantly around the boss, the curved shape of the arms being adapted in use to either aid grip or purchase during tightening or aid grip or purchase during releasing motion of the boss or minimise the risk of overtightening.

According to a third aspect of the invention there is provided a method of connecting two items together, the method including the use of a knob, key, handle or lever with a central boss from which extend at least two curved, in plan, arms, the curved shape of the arms being adapted, in use, to either aid grip or purchase during tightening or aid grip or purchase during releasing motion of the boss or to minimise the risk of overtightening.

The central boss can include a threaded bore so that the knob acts as a nut or can include a threaded spindle so the knob acts as a bolt.

The central boss can include a flange in juxtaposition with one surface of the arms, the flange, in use, is adapted to be used for a variety of purposes. For example the flange can be used to compress a spring when the knob is being tightened or to aid in moving the knob in push pull situations.

The knob can be injection moulded from a plastics or reinforced plastics material or cast, fabricated or otherwise manufactured from a metal or metal alloy material.

Further aspects of the invention which should be considered in all its novel aspects will become apparent from the following description which is given by way of example only.

### DESCRIPTION OF THE DRAWINGS

Examples of the invention will now be described with reference to the accompanying drawing in which:

FIG. 1 is a plan view of a first example of knob or key according to the invention;

FIG. 2 is a side view of the first example shown in FIG. 1;

FIG. 3 is a perspective view of the first example of knob or key shown in FIGS. 1 and 2;

FIG. 4 is a plan view of a second example of knob according to the invention;

FIG. 5 is a side view of the second example of knob shown in FIG. 4; and

FIG. 6 is a perspective view of the second example of knob or key according to the invention shown in FIGS. 4 and 5.

### DESCRIPTION OF THE EXAMPLES

The examples of the invention will be described with reference to a knob for use to join two or members together. For example the knob can be used to tighten, clamp or otherwise engage two or more members together where the knob is to be easily released or undone or tightened to be very hard to remove. An example of such a situation is where a wing nut or the like might be used. The two examples of the invention shown in the drawing will be identified by the same numerals but their modes of operation and uses are different as described.

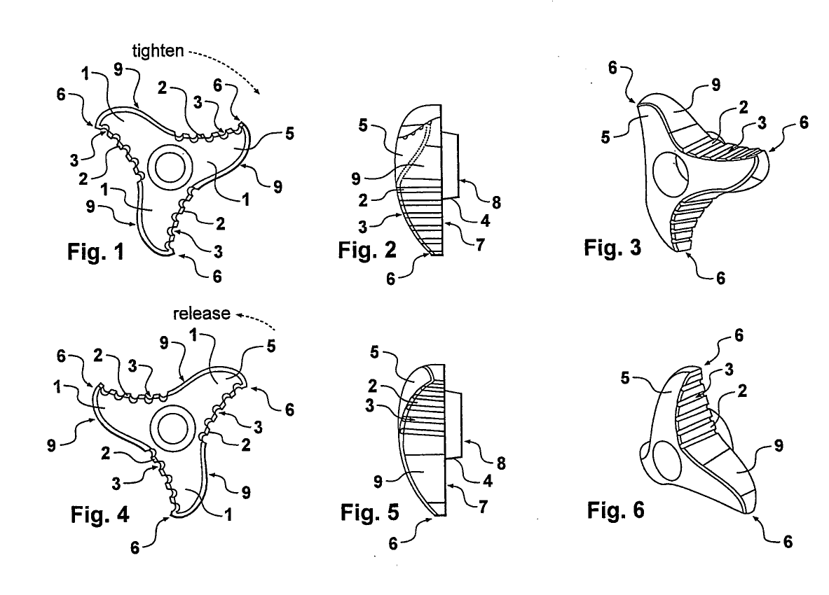

In the first example shown in FIGS. 1 to 3 is a knob designed to be easy to turn and tighten. The knob has as indicated by arrows 1 three arms extending from a central boss 4. The arms 1 are curved in plan as can be seen in FIG. 1. Preferably the curved shape between adjacent arms is sinusoidal in shape extending from points 6. Part of the curved shape 2 between adjacent arms I is provided with ribs or recesses 3 which in use act to provide additional grip to a user of the knob. The surface 5 of each of the arms 1 is curved from the boss 4 toward the distal ends of the arms near to points 6. The other surface 7 is generally planar and spaced from the region 8 of the boss 4.

The region 8 of the central boss 4 has incorporated therein a thread or a spindle (not shown) so that the knob acts as either a nut on an independent bolt or the knob and spindle combination act as a bolt.

In the second example shown in FIGS. 4 to 6 the knob is generally similar to that shown in the first example but is a mirror image thereof and as stated above similar parts are referenced by the same numerals to those used in the first example.

In use the knob shown in FIGS. 1 to 3 is adapted in use to aid grip or purchase during tightening. The curved shape of the arms in this example acts as a fulcrum for aiding in tightening clockwise rotation (arrow shown). An advantage in this orientation is that the curved region 9 which has no ribs or recesses makes it harder to remove the knob because a users hand and/or fingers tend to slip or slide on the curved region 9. The ribs or recesses 3 act as a finger or hand grip region which aids in tightening of the knob.

The knob shown in FIGS. 4 to 6 is adapted in use to aid grip or purchase during release or untightening motion of the boss in an anti-clockwise motion (arrow shown). The ribs or recesses 3 act as a finger or hand grip region which aids in releasing of the knob. An advantage in this orientation is that the curved region 9 with no ribs or recesses makes it harder to tighten and therefore the knob will be easier to remove.

In an alternative construction not shown in the drawing the other surface 7 of the central boss 4 can include a flange. The flange (not shown) can be formed integrally with the central boss 4, the surface 7 and the face of the arms 1 opposite the face 5. The flange, in use, is adapted to be used for a variety of purposes. For example, the flange can be used to compress a spring resting against surface 7 when the knob is being tightened or the flange can be used as an aid in moving the knob in push pull situations.

It will be appreciated by a skilled addressee that a knob of this construction has a very wide number of uses and all are contemplated to fall within the scope hereof.

Particular examples of the invention have been described and it is envisaged that minor modifications can take place without departing from the scope of the attached claims.

1. A hand operated knob, key, handle or lever with a central boss from which extend at least two curved in plan arms, part of the curved surface of each arm having ribs or recesses, the curved shape of the arms being arranged in use to yield either an aid to grip or purchase during tightening or an aid to grip or purchase during releasing motion of the boss.

2. A hand operated knob, key, handle or lever with a central boss from which extend three curved in plan arms spaced equidistantly around the boss, part of the curved surface of each arm having ribs or recesses, the curved shape of the arms being arranged in use to yield either an aid to grip or purchase during tightening or an aid to grip or purchase during releasing motion of the boss or to minimise the risk of overtightening during tightening motion of the boss.

3. The hand operated knob, key, handle or lever as claimed in claim 1 wherein the central boss includes either a threaded bore so that the knob acts as a nut or a threaded spindle so the knob acts as a bolt.

4. The hand operated knob, key, handle or lever as claimed in claim 1 wherein the knob is injection moulded from a plastics or reinforced plastics material, cast, fabricated or otherwise manufactured from a metal or metal alloy material.

5. The hand operated knob, key, handle or lever as claimed in claim 1 wherein the curved shape between adjacent arms is sinusoidal in shape.

6. The hand operated knob, key, handle or lever as claimed in claim 1 wherein the surface of each of the arms is curved from the boss toward distal ends of the arms near to points of the arms.

7. The hand operated knob, key, handle or lever as claimed in claim 6 wherein the other surface is generally planar and spaced from the region of the boss which has incorporated therein a thread or a spindle.

8. The hand operated knob, key handle or lever as claimed in claim 7 wherein the other surface has formed integrally therewith a flange.

9. The hand operated knob, key, handle or lever as claimed in claim 1 and substantially as hereinbefore described with reference to the accompanying drawings.

10. A method of connecting two items together, the method including the use of a hand operated knob, key, handle or lever with a central boss from which extend at least two curved in plan arms, part of the curved surface of each arm having ribs or recesses, the curved shape of the arms being arranged in use to yield either an aid to grip or purchase during tightening or an aid to grip or purchase during releasing motion of the boss or to minimise the risk of overtightening during tightening motion of the boss.

11. (canceled)
